(19) United States
(12) Patent Application Publication
(10) Pub. No.: US 2013/0111586 A1
(43) Pub. Date: May 2, 2013

(54) COMPUTING SECURITY MECHANISM

(71) Applicant: Warren Jackson, San Francisco, CA (US)

(72) Inventor: Warren Jackson, San Francisco, CA (US)

(21) Appl. No.: 13/282,827

(22) Filed: Oct. 27, 2011

(51) Int. Cl. G06F 11/00

(52) U.S. Cl. 726/23

(57) ABSTRACT

Interaction involving a computing system and/or applications accessible via the computing system is monitored. As a consequence of determining that the monitored interaction is suspicious, a security mechanism is invoked in connection with the computing system.

### BACKGROUND

Usernames, passwords, username and password pairs, physical keys, digital certificates, and biometric characteristics often are used as authentication information used in connection with regulating access to computing systems and resources. However, such forms of authentication information may not always be immune from subversion. If a hacker or a malicious program is able to successfully bypass an authentication-based scheme for regulating access to a computing system or resource, the hacker or malicious program thereafter may have unfettered and unlimited access to the computing systems and resources.

### BRIEF DESCRIPTION OF THE DRAWINGS

FIG. 1 is a block diagram of an example of a communications system.

FIGS. 2-4 are flowcharts that illustrate examples of processes for monitoring interaction via a computing system and invoking security mechanisms in response to detecting suspicious interaction.

### DETAILED DESCRIPTION

If a hacker or malicious program is able to successfully bypass an authentication mechanism employed to regulate access to a computing system and/or other resources accessible via the computing system, the hacker or malicious program thereafter may have unfettered and unlimited access to the computing system and/or resources. Therefore, even if a security mechanism has been satisfied and access to a computing system and/or resources accessible via the computing system has been granted to an identity, in an effort to elevate the security of the computing system and/or resources accessible via the computing system, techniques may be employed to re-authenticate the identity, forcing the identity to repeatedly demonstrate that the identity is entitled to access the computing system and/or resources accessible via the computing system. This approach to protecting the security of the computing system and/or resources accessible via the computing system may be especially effective if the techniques used to re-authenticate the identity are not readily apparent and/or are applied continually or at random intervals, because a hacker or malicious program may find it difficult to subvert re-authentication techniques if the hacker or malicious program is not aware of how such re-authentication is accomplished and/or when it is to occur.

In some implementations, after a user logs in to a computing system with an identity, the user's interaction with different user applications accessible via the computing system is monitored and compared to known user application usage patterns of the user. If the user's monitored interaction with the user applications is relatively consistent with known usage patterns associated with the identity, no suspicion may be triggered and the user may be allowed to continue to use the computing system. In contrast, if the user's monitored interaction with the user applications diverges from the known usage patterns associated with the identity, the user's monitored interaction may be determined to be suspicious and may trigger the invocation of a security mechanism as a result. In this manner, the user's interaction with the user applications may serve as a form of continual re-authentication of the identity. While this re-authentication may be transparent to the user, the user actually may be continually demonstrating that he/she is who he/she claims to be (i.e., a user associated with the identity used to log-in to the computing system) by virtue of his/her interaction with the user applications. If, however, the user's interaction with the user applications diverges from the known usage patterns associated with the identity, suspicions may be triggered that the computing system is not actually being used by a user associated with the purported identity.

For example, it may be known that, after a particular user of a computing system logs in to the computing system, the user typically opens an e-mail client application to check his e-mail, then opens an Internet browser and navigates to a first website to check the weather and then a second website to check the stock market, and then opens a spreadsheet application to perform some work-related data processing. Consequently, if the user were to log-in to the computing system and immediately open a database application and start accessing and copying different records and then the user were to open an invoicing application and start copying saved invoices, the user's interaction with the user applications may be determined to be suspicious because it diverges from the user's known user application usage patterns. As a result, a security mechanism may be invoked that is intended (i) to confirm that it is, in fact, the user accessing the computing system and not a hacker or a malicious program accessing the computing system and/or (ii) to prevent an unauthorized user or malicious program from further accessing the computing system. For example, additional authentication information may be requested before access to the computing system may be resumed.

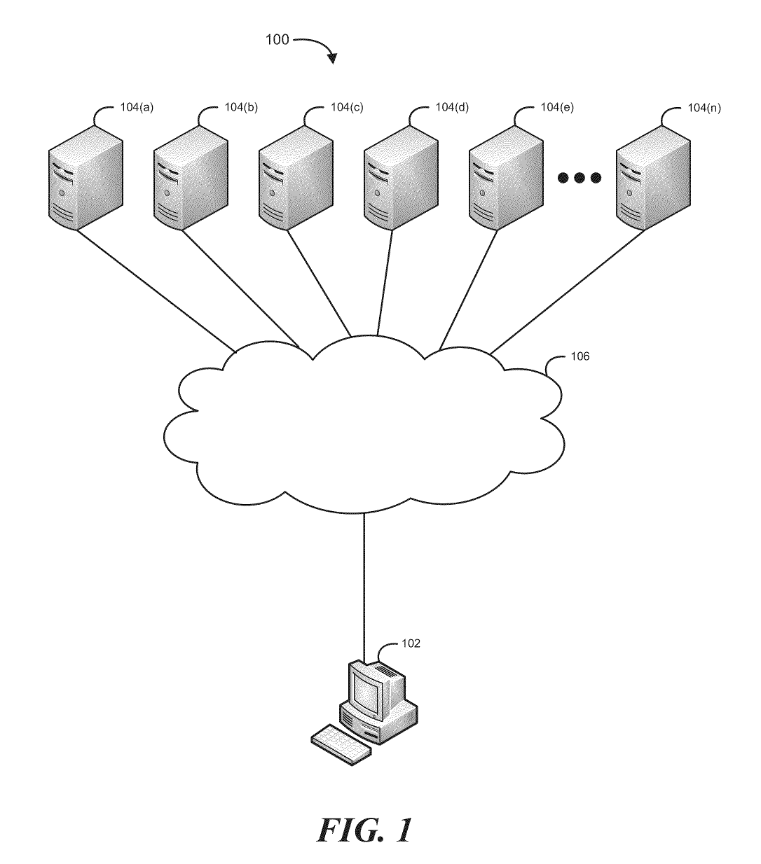

FIG. 1 is a block diagram of an example of a communications system 100. As illustrated in FIG. 1, the communications system includes a user computing device 102 communicatively coupled to a number of host computing devices 104(a)-104(n) by a network 106.

User computing device 102 may be any of a number of different types of computing devices including, for example, a personal computer, a special purpose computer, a general purpose computer, a combination of a special purpose and a general purpose computer, a laptop computer, a tablet computer, a netbook computer, a smart phone, a mobile phone, a personal digital assistant, etc. In addition, user computing device 102 typically has one or more processors for executing instructions stored in storage and/or received from one or more other electronic devices as well as internal or external storage components for storing data and programs such as an operating system and one or more application programs. Host computing devices 104(a)-104(n), meanwhile, may be servers having one or more processors for executing instructions stored in storage and/or received from one or more other electronic devices as well as internal or external storage components storing data and programs such as operating systems and application programs. Network 106 may provide direct or indirect communication links between user computing device 102 and host computing devices 104(a)-104(n). Examples of network 106 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

By virtue of the communicative coupling provided by network 106, user computing device 102 may be able to access and interact with services and other user applications hosted on one or more of host computing devices 104(a)-104(n). Additionally or alternatively, user computing device 102 may be able to access data stored by one or more of host computing devices 104(a)-104(n) also by virtue of the communicative coupling provided by network 106.

In some implementations, the storage components associated with user computing device 102 store one or more application programs that, when executed by the one or more processors of user computing device 102, cause user computing device 102 to only grant access to computing device 102, one or more of host computing devices 104(a)-104(n), and/or communications system 100 more generally to authenticated identities. In some implementations, the storage components associated with user computing device 102 also may store one or more application programs that, when executed by the one or more processors of user computing device 102, cause user computing device 102 to generate models of interaction via user computing device 102, including, for example, interaction with application programs executing on user computing device 102 and data stored in the storage components associated with user computing device 102 and/or interaction with application programs executing on one or more of host computing devices 104(a)-104(n) and data stored in the storage components associated with one or more of host computing devices 104(a)-104(n). In addition, when executed by the one or more processors of user computing device 102, these application programs may monitor interaction via computing device 102, including, for example, interaction with application programs executing on user computing device 102 and data stored in the storage components associated with user computing device 102 and/or interaction with application programs executing on one or more of host computing devices 104(a)-104(n) and data stored in the storage components associated with one or more of host computing devices 104(a)-104(n). Furthermore, these application programs, when executed by the one or more processors of user computing device 102, may compare the monitored interaction via user computing device 102 to the modeled interaction via user computing device 102, determine that the monitored interaction via user computing device 102 is suspicious if it diverges from the modeled interaction via user computing device 102, and invoke a security mechanism in response to such a determination that the monitored interaction via user computing device 102 is suspicious.

In alternative implementations, the storage components associated with one or more of host computing devices 104(a)-104(n) store one or more application programs that, when executed by the one or more processors of these one or more host computing devices 104(a)-104(n), cause these one or more host computing devices 104(a)-104(n) to only grant access to user computing device 102, one or more of host computing devices 104(a)-104(n), and/or communications system 100 more generally to authenticated identities. In addition, in such implementations, the storage components associated with these one or more host computing devices 104(a)-104(n) also may store one or more application programs that, when executed by the one or more processors of these one or more host computing devices 104(a)-104(n), cause these one or more host computing devices 104(a)-104(n) to generate models of interaction via user computing device 102, including, for example, interaction with application programs executing on user computing device 102 and data stored in the storage components associated with user computing device 102 and/or interaction with application programs executing on one or more of host computing devices 104(a)-104(n) and data stored in the storage components associated with one or more of host computing devices 104(a)-104(n). In addition, when executed by the one or more processors of these one or more host computing devices 104(a)-104(n), these application programs may monitor interaction via computing device 102, including, for example, interaction with application programs executing on user computing device 102 and data stored in the storage components associated with user computing device 102 and/or interaction with application programs executing on one or more of host computing devices 104(a)-104(n) and data stored in the storage components associated with one or more of host computing devices 104(a)-104(n). Furthermore, these application programs, when executed by the one or more processors of these host computing devices 104(a)-104(n) may compare the monitored interaction via user computing device 102 to the modeled interaction via user computing device 102, determine that the monitored interaction via user computing device 102 is suspicious if it diverges from the modeled interaction via user computing device 102, and invoke a security mechanism in response to such a determination that the monitored interaction via user computing device 102 is suspicious.

In still other alternative implementations, application programs stored in the storage components associated with user computing device 102 and application programs stored in the storage components associated with one or more of the host computing devices 104(a)-104(n) may coordinate, when executed by their corresponding processors, to generate models of interaction via user computing device 102, to monitor interaction via user computing device 102, to compare the monitored interaction via user computing device 102 to the modeled interaction via user computing device 102, and to invoke a security mechanism in response to determining that the monitored interaction via user computing device 102 is suspicious.

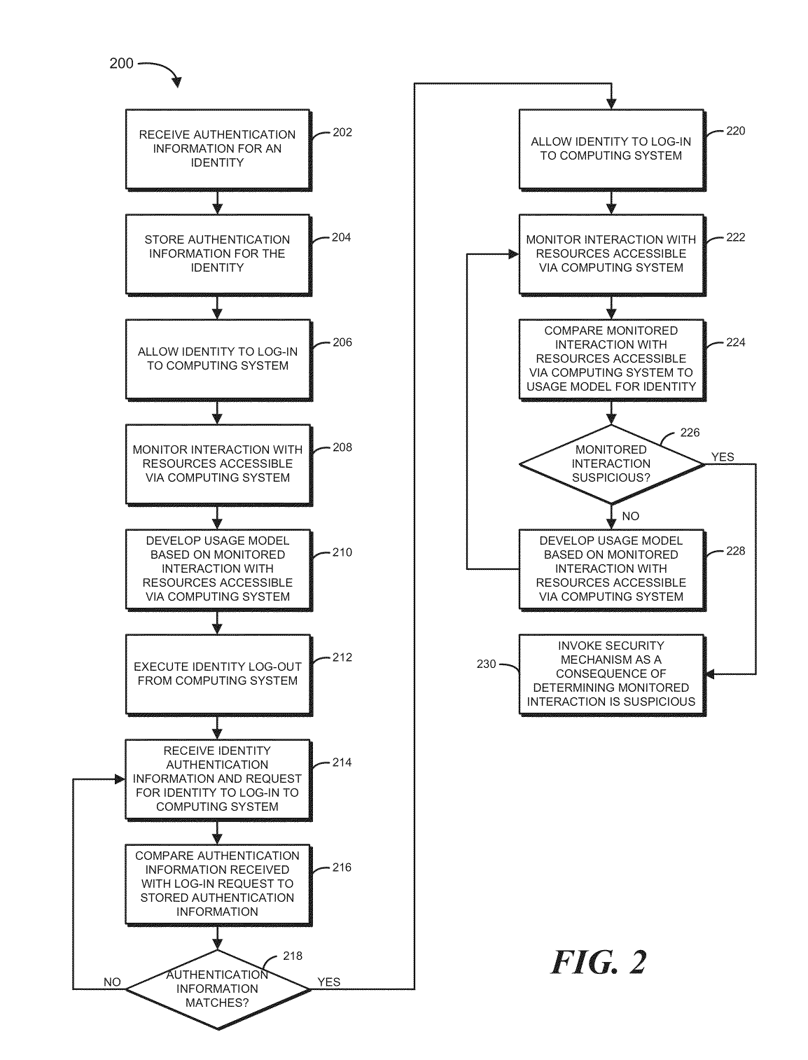

FIG. 2 is a flowchart 200 that illustrates an example of a process for monitoring interaction via a computing system (e.g., a personal computer communicatively coupled to a communications system including one or more other computing devices) and invoking a security mechanism in response to detecting suspicious interaction. The process illustrated in the flowchart 200 may be performed by one or more computing devices such as, for example, user computing device 102 of FIG. 1, one or more of host computing devices 104(a)-104(n) of FIG. 1, or a combination of user computing device 102 and one or more of host computing devices 104(a)-104(n) of FIG. 1.

At 202, authentication information is received for an identity (e.g., a registered user account of the computing system). In some cases, this receipt of authentication information may correspond to the identity's registration with the computing system and, as such, may represent the first time authentication information for the identity has been received. In such cases, relatively extensive authentication information may be solicited and received for the identity. For example, in addition to a username and password or other form of authentication information (e.g., a key, certificate, or biometric characteristics), answers to one or more security questions (e.g., mother's maiden name, hometown, favorite color, etc.) and other details about the identity may be solicited and received. In other cases, the identity already may be registered with the computing system and the authentication information received may be relatively routine (e.g., a username and password pair). Alternatively, even if the identity has registered with the computing system previously, in some cases, relatively rigorous authentication information may be solicited and received for the identity at 202. At 204, the authentication information for the identity is stored. For example, if the receipt of authentication information at 202 represents the first time that the authentication information has been received for the identity, the received authentication information may be stored at 204 to enable use of the authentication information to authenticate the identity in future sessions.

At 206, the identity is allowed to log-in to the computing system. For example, if the receipt of authentication information at 202 corresponds to the identity's initial registration with the computing system, the identity may be allowed to log-in to the computing system at 206 as a consequence of having registered with the computing system. Alternatively, if the identity previously has registered with the computing system, the identity may be allowed to log-in to the computing system at 206 as a consequence of having provided satisfactory authentication information at 202.

While the identity remains logged-in to the computing system, interaction at the computing system with resources accessible via the computing is monitored at 208. In some implementations, this monitoring may involve monitoring the interaction with user applications stored locally at the computing system and/or user applications available over a network connection (e.g., the Internet). Such user applications may include applications that execute on top of and through operating systems provided at the computing system(s) on which the applications run and that provide functionality to the end user as opposed to resources of the computing system. Consequently, this monitoring of the interaction with the user applications may not involve monitoring system calls, call stack data, and other low-level/system-level operations. Instead, this application monitoring may be performed at a higher level (i.e., the application level) of the software stack than these low level operations.

In one example, the identity of one or more user applications launched after logging-in the identity to the computing system may be monitored and/or the order in which different user applications are launched after logging-in the identity to the computing system may be monitored. Furthermore, after the various different applications have been launched, the order and/or frequency with which the different applications are switched back and forth also may be monitored. Additionally or alternatively, use of the one or more launched user applications to access files stored locally or on network-connected storage resources may be monitored. For example, the number and/or frequency of files accessed using the one or more launched user applications may be monitored as may be the identity of the files actually accessed.

The use of different input operations to execute certain functionality within one or more of the launched user applications also may be monitored. For example, if one of the launched user applications is a word processing application that provides multiple different input operations for causing a “cut-and-paste” operation to be performed (e.g., a series of computer mouse clicks on a menu interface or the use of one or more keystroke shortcut combinations), the frequency with which the different input operations for causing the “cut-and-paste” operation are used may be monitored. Similarly, if one of the launched user applications is a database application that provides multiple different input operations to access certain stored data, the frequency with which the different input operations are used to access data may be monitored. Other forms of interaction within individual user applications also may be monitored. For example, if a user is using an authoring application (e.g., a word processing application), the frequency with which the user manually executes save commands may be monitored. Additionally or alternatively, if a user is using an Internet browser, the various different network addresses (e.g., web pages) that the user accesses using the Internet browser may be monitored as well.

Other behaviors at, associated with, or caused by the computing system while the identity remains logged-in to the computing system also may be monitored. For example, the accessing of network-connected file servers by the computing system may be monitored while the identity remains logged-in to the computing system. Additionally or alternatively, the copying of files stored locally and/or on network-connected storage resources to local storage resources also may be monitored while the identity remains logged-in to the computing system.

At 210, a usage model for the identity is developed based on the interaction with resources accessible via the computing system that was monitored at 208. In some cases (e.g., if the identity was not previously registered with the computing system), developing the usage model for the identity may include creating the model in the first instance and adapting it based on ongoing monitoring of the interaction with resources accessible via the computing system. In other cases, the usage model for the identity already may exist (e.g., if the identity had previously registered with the computing system), and developing the usage model for the identity may involve adapting the usage model for the identity based on the interaction with resources accessible via the computing system that was monitored at 208.

At 212, a log-out from the computing system is executed for the identity. This log-out may be executed in response to a request received from a user associated with the identity to log-out from the computing system. Alternatively, this log-out may be executed in response to one or more other factors, such as, for example, an extended period of inactivity.

At some time after executing the log-out from the computing system for the identity, authentication information for the identity is received again along with a request for the identity to be logged-in to the computing system at 214. In some cases, the authentication information received at 214 may not be as extensive as that received at 202. For example, if the authentication information received at 202 was received in connection with registering the identity with the computing system, relatively extensive authentication may have been solicited and received at 202, whereas if the authentication information received at 214 is received in connection with a routine log-in request, only relatively routine authentication information (e.g., a username and password pair) may be solicited and received at 214. At 216, the authentication information received at 214 is compared to the stored authentication information. For example, if the authentication information received at 214 is a username and password pair, the received password may be compared to a stored password corresponding to the received username. Then, at 218, a determination is made as to whether the authentication information received at 214 matches the stored authentication information. In the event that the authentication information received at 214 does not match the stored authentication information, the request to log-in to the computing system may be denied and the process may wait until authentication information and another request to log-in to the computing system are received again at 214. Alternatively, if the authentication information received at 214 matches the stored authentication information, the identity is allowed to log-in to the computing system at 220.

Then, at 222, while the identity remains logged-in to the computing system, interaction with resources accessible via the computing system is monitored. The monitoring of interaction with resources accessible via the computing system at 222 may be similar to the monitoring of interaction with resources accessible via the computing system at 208.

For example, in some implementations, the monitoring at 222 may involve monitoring interaction with user applications stored locally and/or user applications available over a network connection (e.g., the Internet). More particularly, the identity of one or more user applications launched after logging-in the identity to the computing system may be monitored and/or the order in which the different user applications are launched after logging-in the identity to the computing system may be monitored. Furthermore, after the various different user applications have been launched, the order and/or frequency with which the different applications are switched back and forth also may be monitored. Additionally or alternatively, use of the one or more launched user applications to access files stored locally or on network-connected storage resources may be monitored. For example, the number and/or frequency of files accessed using the one or more user applications may be monitored as may be the identity of the files actually accessed. The use of different input operations to execute certain functionality within one or more of the launched user applications also may be monitored as may other forms of interaction within individual user applications. Additionally or alternatively, if a user is using an Internet browser, the various different network addresses (e.g., web pages) that the user accesses using the Internet browser may be monitored as well. Other behaviors at, associated with, or caused by the computing system while the identity remains logged-in to the computing system also may be monitored. For example, the accessing of network-connected file servers by the computing system may be monitored while the identity remains logged-in to the computing system. Additionally or alternatively, the copying of files stored locally and/or on network-connected storage resources to local storage resources may be monitored while the identity remains logged-in to the computing system.

At 224, the monitored interaction with the resources accessible via the computing system is compared to the usage model for the identity. In some implementations, this may involve identifying the usage model for the identity from among a collection of usage models for different identities (e.g., based on a username and/or authentication information received at 214).

Then, at 226, based on having compared the monitored interaction to the usage model for the identity, a determination is made about whether the monitored interaction is suspicious.

For example, one or more user applications launched after logging-in the identity to the computing system may be compared to one or more user applications known to be launched by a user associated with the identity frequently after logging-in the identity to the computing system. If there is more than a predetermined threshold amount of divergence between the one or more user applications actually launched after logging-in the identity to the computing system and the one or more user applications that the user associated with the identity is known to launch frequently after logging-in to the computing system, the monitored interaction may be determined to be suspicious. Otherwise, the monitored interaction may be determined to be unsuspicious.

The order in which different user applications are launched after logging-in the identity to the computing system also may be compared to an order of user applications a user associated with the identity is known to launch frequently after logging-in to the computing system. If there is more than a predetermined threshold amount of divergence between the order in which the different user applications actually were launched after logging-in the identity to the computing system and the order of user applications that the user associated with the identity is known to launch frequently after logging-in to the computing system, the monitored interaction may be determined to be suspicious. Otherwise, the monitored interaction may be determined to be unsuspicious. Additionally or alternatively, the order and/or frequency with which the different user applications are switched back and forth may be compared to an order and/or frequency with which a user associated with the identity is known to commonly switch back and forth between different user applications. If there is more than a predetermined threshold amount of divergence between the actual order and/or frequency with which the different user applications were switched back and forth and the order and/or frequency with which a user associated with the identity is known to commonly switch back and forth between different user applications, the monitored interaction may be determined to be suspicious. Otherwise, the monitored interaction may be determined to be unsuspicious.

In some implementations, the identity, number, and/or frequency of files accessed using one or more of the launched user applications after logging-in the identity to the computing system may be compared to the identity, number, and/or frequency of files that a user associated with the identity is known to frequently access using one or more of the user applications. If the identity, number, and/or frequency of files actually accessed using the user applications diverges more than a predetermined threshold amount from the identity, number, and/or frequency of files that the user associated with the identity is known to frequently access using the user applications, the monitored interaction may be determined to be suspicious. Otherwise, the monitored interaction may be determined to be unsuspicious.

A user's interaction within one or more individual user applications also may be compared to known usage patterns of a user associated with the identity within user applications. For example, the user's use of different input operations to execute certain functionality within one or more of the user applications also may be compared to input operations that the user associated with the identity is known to use frequently to execute certain functionality within the one or more user applications. In one particular example, if the user associated with the identity is known to use a keystroke shortcut combination to execute a “cut-and-paste” operation within a word processing application approximately 80% of the time while using a series of computer mouse clicks on a menu interface to execute the “cut-and-paste” operation the remaining approximately 20% of the time, the monitored interaction may be determined to be suspicious if, as a consequence of the monitoring, it is observed that the user actually is using the series of computer mouse clicks on the menu interface to execute the “cut-and-paste” operation 75% of the time while only using the keystroke shortcut combination to execute the “cut-and-pate” operation 25% of the time.

Other factors that may be taken into consideration as part of determining if the monitored interaction is suspicious include whether, which, and how frequently the computing system accessed one or more network-connected file servers while the identity is logged-in to the computing system and/or whether, which, how frequently, and how many files stored locally or on network-connected storage resources the computing system copied to a local location while the identity is logged-in to the computing system.

Any combination of the above examples of monitored interaction also may be compared to the usage model developed for the identity as part of determining if the monitored interaction is suspicious. In some implementations, a numeric score may be calculated to represent the divergence between the monitored interaction and the usage model developed for the identity. In such implementations, the monitored interaction may be determined to be suspicious if the numeric score representing the divergence exceeds some predetermined threshold value.

Furthermore, in some implementations, there may be different gradations of suspicious interaction. For example, in implementations in which a numeric score is calculated to represent the divergence between the monitored interaction and the usage model developed for the identity, a first continuous range of values greater than the predetermined threshold value demarcating the boundary between unsuspicious and suspicious interaction may be considered to represent “mildly suspicious” interaction while values of divergence that exceed this range may be considered to represent “highly suspicious” interaction. In such implementations, the magnitude of the suspicion may be a function of with which resources the user's interaction was considered to be suspicious. For example, some applications accessible via the computing system may be considered to be low security applications while others may be considered to be high security applications. If monitored interaction with one or more of the low security applications is considered suspicious, the overall magnitude of the suspicion may not be determined to be too severe. In contrast, if monitored interaction with one or more of the high security applications is considered suspicious, the overall magnitude of the suspicion may be determined to be relatively high.

If 226 results in a determination that the monitored interaction with the resources accessible via the computing system is not suspicious, the usage model for the identity may be further developed at 228 based on the interaction with the resources available via the computing system that was monitored at 222. For example, a learning algorithm may be employed to adapt the usage model for the identity based on the interaction with resources accessible via the computing system that was monitored at 222. Then, the process may return to 222 to continue to monitor interaction with resources accessible via the computing system.

Alternatively, if 226 results in a determination that the monitored interaction with the resources accessible via the computing system is suspicious, at 230 a security mechanism is invoked as a consequence of having determined that the monitored interaction with the resources accessible via the computing system is suspicious.

For example, in some implementations, the provision of authentication information may be solicited before allowing further access to the computing system. In some cases, the authentication information solicited may be the same as originally provided to log-in the identity to the computing system (e.g., a username and password pair). In other cases, the determination that the monitored interaction is suspicious may trigger solicitation of more extensive authentication information (e.g., a username and password pair plus answers to one or more additional security questions). Alternatively, in some implementations, in response to determining that the monitored interaction is suspicious, the identity may be logged-out of the computing system immediately (and potentially for a predetermined and perhaps extended period of time). Additionally or alternatively, in implementations in which the computing system is deployed in a networked environment, determination that the monitored interaction is suspicious may trigger an alert to be sent to a network environment monitoring apparatus. Alerting the network environment monitoring apparatus in this manner may cause the network environment monitoring apparatus to be on the lookout for other potentially suspicious behavior in the network environment that is potentially indicative of a more extensive attack or an actual breach. Additionally or alternatively, the alert may cause the network environment monitoring apparatus to commence observation and logging of network events (or increase the observation and logging of network events if such observation and logging of network events already has been initiated), for example, to facilitate forensic evaluation of the nature of the potential attack and identification of the attacking agent if an attack is indeed underway. Furthermore, in response to determining that the monitored interaction is suspicious, the computing system itself or the network environment monitoring apparatus (or some other entity alerted by the computing system) may invoke offensive countermeasures intended to defeat or slow an attack and/or to mitigate any damage already caused by an attack.

In some implementations, the severity of the security mechanism invoked responsive to determining that the monitored interaction is suspicious may depend on a measure of the magnitude of how suspicious the monitored interaction was determined to be. For example, if the magnitude of the suspicion caused by the monitored interaction was relatively high, access to all resources accessible via the computing system may be denied. Alternatively, if the magnitude of the suspicion caused by the monitored interaction was relatively low, access to some resources accessible via the computing system may continue to be allowed while access to other resources accessible via the computing system may be denied.

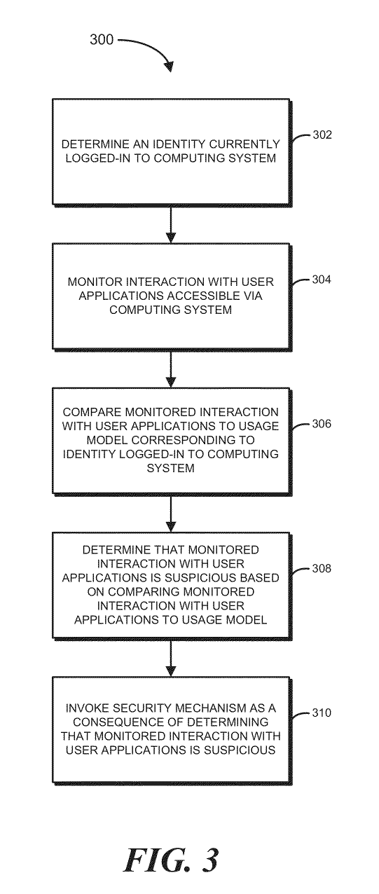

FIG. 3 is a flowchart 300 that illustrates another example of a process for monitoring interaction via a computing system and invoking security mechanisms in response to detecting suspicious interaction. The process illustrated in the flowchart 300 may be performed by one or more computing devices such as, for example, user computing device 102 of FIG. 1, one or more of host computing devices 104(a)-104(n) of FIG. 1, or a combination of user computing device 102 and one or more of host computing devices 104(a)-104(n) of FIG. 1.

At 302 the identity currently logged-in to a computing system is determined. For example, the identity currently logged-in to the computing system may be determined based on a username, account information, or other data provided in connection with the identity being logged-in to the computing system.

At 304, the interaction with user applications that are accessible via the computing system that is occurring at or in association with the computing system is monitored. For example, interaction with user applications executing at the computing system and/or applications that are executing on remote computing systems but that are being accessed by the computing system may be monitored.

At 306, the monitored interaction with the user applications is compared to a usage model corresponding to the identity determined to be logged-in to the computing system. This usage model may have been developed for the identity previously and identified from among a collection of usage models for different identities as a result of having determined which identity currently is logged-in to the computing system at 302.

At 308, the monitored interaction with the user applications is determined to be suspicious based on having compared the monitored interaction with the user applications to the usage model for the identity. Then, at 310, as a consequence of having determined that the monitored interaction with the user applications is suspicious, a security mechanism is invoked.

As described above, techniques disclosed herein for monitoring interaction involving a computing system and invoking a security mechanism in response to determining that the monitored interaction is suspicious may be especially effective because a hacker or a malicious program may be unaware that the monitoring is occurring, or, even if the hacker or malicious program is aware that the monitoring is occurring, the hacker or malicious program may be unaware of what behavior(s) are being monitored. Furthermore, the hacker or malicious program may be unaware of what type of security mechanism will be invoked in the event that suspicious interaction is detected. Consequently, without advanced knowledge of the security mechanism that will be invoked, it may be difficult for the hacker or malicious program to circumvent the security mechanism after it ultimately is invoked.

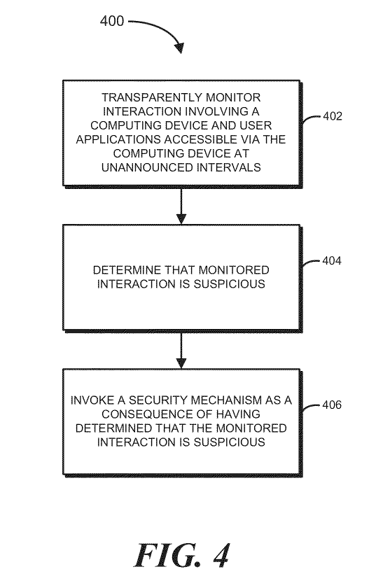

Applying these principles of masking the act of monitoring interaction from a hacker or malicious program, FIG. 4 is a flowchart 400 that illustrates an example of a process for monitoring interaction involving a computing device and invoking security mechanisms in response to detecting suspicious interaction. The process illustrated in the flowchart 400 may be performed by one or more computing devices such as, for example, user computing device 102 of FIG. 1, one or more of host computing devices 104(a)-104(n) of FIG. 1, or a combination of user computing device 102 and one or more of host computing devices 104(a)-104(n) of FIG. 1.

At 402, interaction involving the computing device and user applications that are accessible via the computing device (e.g., user applications executing at the computing device and/or user applications accessible to the computing device over a network connection) is monitored transparently at one or more unannounced intervals. Such transparent monitoring may involve monitoring that is performed in the background and/or by a remote device and that is performed in a fashion that is not immediately obvious to an end user of the computing device or a malicious program attempting to attack the computing device. For example, the monitoring may take place without causing any unordinary displays on any display device(s) associated with the computing device that would not occur during the regular operation of the user applications and/or the operating system and other standard utilities associated with the computing device. Additionally or alternatively, the monitoring may take place without requesting any unordinary input that would not be requested during the regular operation of the user applications and/or the operating system and other standard utilities associated with the computing device. In fact, without performing an extensive examination of all of the processes executing at or in association with the computing device, it may be extremely difficult to detect that the monitoring is occurring at all. The monitoring also may take place at one or more unannounced intervals. Therefore, even if a hacker or a malicious program somehow knows that interaction will be monitored for suspicious behavior at some point, the hacker or malicious program may not known when such monitoring will occur and, consequently, the hacker or malicious program will not know when its behavior must conform to an unsuspicious profile. The unannounced monitoring of interaction may occur at regular intervals or at aperiodic or random intervals.

At 404, the monitored interaction involving the computing system is determined to be suspicious. In some cases, the monitored interaction determined to be suspicious may be interaction that occurred in a single monitored interval. In other cases, the monitored interaction determined to be suspicious may be interaction that occurred across multiple different monitored intervals. Then, at 406, as a consequence of having determined that the monitored interaction involving the computing system is suspicious, a security mechanism (e.g., any one or combination of the different security mechanisms described above) is invoked in connection with the computing system. The security mechanism invoked may be relatively rigorous and come as a surprise to a hacker or malicious program attempting to attack the computing system so that it may be difficult for the hacker or malicious program to circumvent the invoked security mechanism. For example, the invoked security mechanism may deny all access to the computing system for some predetermined period of time. Alternatively, the invoked security mechanism may require extensive authentication information—that a hacker or malicious program may not be prepared to provide—before allowing further access to the computing system. Additionally or alternatively, the invoked security mechanism may involve event monitoring or offensive countermeasures that are initiated transparently and that operate to the detriment of a hacker or a malicious program in the long run. Because such measures may be initiated transparently, a hacker or malicious program may not be aware that they are even being employed and, therefore, a hacker or malicious program may not be able to initiate its own responsive measures.

A number of methods, techniques, systems, and apparatuses have been described. However, additional implementations are contemplated. For example, in some implementations, different usage models for determining if monitored interaction is suspicious may be developed for the same identity depending on locations from which the identity is used to log-in to the computing system. For example, the user who corresponds to the identity may log-in to the computing system regularly both from home and from work. However, the user's interaction with the computing system may vary differ considerably depending on whether the user logs in to the computing system from home or from work. Therefore, one usage model may be developed for the identity for use in identifying suspicious behavior when the identity logs in to the computing system from the corresponding user's home, and another usage model may be developed for the identity for use in identifying suspicious behavior when the identity logs in to the computing system from the corresponding user's office.

The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed is:

1. A computer-implemented method comprising:
determining, using a processor, an identity currently logged-in to a computing system that provides access to a number of user applications;
while the identity remains logged-in to the computing system, monitoring, using a processor, interaction with multiple of the user applications accessible via the computing system;
comparing, using a processor, the monitored interaction with the multiple user applications to a system resource usage model corresponding to the identity determined to be logged-in to the computing system currently;
based on a result of comparing the monitored interaction with the multiple user applications to the system resource usage model corresponding to the identity determined to be logged-in to the computing system, determining, using a processor, that the monitored interaction with the multiple user applications is suspicious; and
as a consequence of determining that the monitored interaction with the multiple user applications is suspicious, invoking, using a processor, a security mechanism in connection with the computing system.

2. The computer-implemented method of claim 1 wherein:
monitoring interaction with multiple of the user applications accessible via the computing system includes monitoring an order in which a user accesses the multiple user applications;
comparing the monitored interaction with the multiple user applications to the system resource usage model corresponding to the identity determined to be logged-in to the computing system includes comparing the order in which the user accesses the multiple user applications to the system resource usage model; and
determining that the monitored interaction with the multiple user applications is suspicious includes determining that the order in which the user accesses the multiple user applications is suspicious based on a result of comparing the order in which the user accesses the multiple user applications to the system resource usage model.

3. The computer-implemented method of claim 2 wherein:
monitoring the order in which the user accesses the multiple user applications includes monitoring the order in which the user launches the multiple user applications;
comparing the order in which the user accesses the multiple user applications to the system resource usage model includes comparing the order in which the user launches the multiple user applications to the system resource usage model; and
determining that the order in which the user accesses the multiple user applications is suspicious includes determining that the order in which the user launches the multiple user applications is suspicious based on a result of comparing the order in which the user launches the multiple user applications to the system resource usage model.

4. The computer-implemented method of claim 1 wherein:
monitoring interaction with multiple of the user applications accessible via the computing system includes identifying individual user applications accessed by a user;
comparing the monitored interaction with the multiple user applications to the system resource usage model corresponding to the identity determined to be logged-in to the computing system includes comparing at least some of the individual user applications accessed by the user to the system resource usage model; and
determining that the monitored interaction with the multiple user applications is suspicious includes determining that the user's access of one or more of the individual user applications is suspicious based on a result of comparing at least some of the individual user applications accessed by the user to the system resource usage model.

5. The computer-implemented method of claim 1 wherein:
monitoring interaction with multiple of the user applications accessible via the computing system includes monitoring accessing of files stored in computer memory storage by one or more of the multiple user applications;
comparing the monitored interaction with the multiple user applications to the system resource usage model corresponding to the identity determined to be logged-in to the computing system includes comparing the accessing of files stored in computer memory storage by the one or more user applications to the system resource usage model corresponding to the identity determined to be logged-in to the computing system; and
determining that the monitored interaction with the multiple user applications is suspicious includes determining that the accessing of files stored in computer memory storage by the one or more user applications is suspicious based on a result of comparing the accessing of files stored in computer memory storage by the one or more user applications to the system resource usage model corresponding to the identity determined to be logged-in to the computing system.

6. The computer-implemented method of claim 1 further comprising monitoring copying, initiated by the computing system, of files stored in computer memory storage and accessible via the computing system, wherein:
comparing the monitored interaction with the multiple user applications to the system resource usage model corresponding to the identity determined to be logged-in to the computing system further comprises comparing the monitored copying of files initiated by the computing system to the system resource usage model corresponding to the identity determined to be logged-in to the computing system; and
determining that the monitored interaction with the multiple user applications is suspicious further includes determining that the monitored interaction with the multiple user applications and the copying of files initiated by the computing system are suspicious based on a result of comparing the monitored copying of files initiated by the computing system to the system resource usage model corresponding to the identity determined to be logged-in to the computing system.

7. The computer-implemented method of claim 1 wherein:
monitoring interaction with multiple of the user applications accessible via the computing system includes monitoring, for a particular user application that provides multiple different input sequences for executing the same operation, input sequences input by a user to execute the operation within the particular user application;
comparing the monitored interaction with the multiple user applications to the system resource usage model corresponding to the identity determined to be logged-in to the computing system includes comparing the monitored input sequences input by the user to execute the operation within the particular user application to the system resource usage model corresponding to the identity determined to be logged-in to the computing system; and
determining that the monitored interaction with the multiple user applications is suspicious includes determining that the monitored input sequences input by the user to execute the operation within the particular user application are suspicious based on a result of comparing the monitored input sequences input by the user to execute the operation within the particular user application to the system resource usage model corresponding to the identity determined to be logged-in to the computing system.

8. The computer-implemented method of claim 1 further comprising monitoring accessing, by the computing system, of file servers accessible via the computing system, wherein:
comparing the monitored interaction with the multiple user applications to the system resource usage model corresponding to the identity determined to be logged-in to the computing system further comprises comparing the monitored accessing of files servers accessible via the computing system to the system resource usage model corresponding to the identity determined to be logged-in to the computing system; and
determining that the monitored interaction with the multiple user applications is suspicious further includes determining that the monitored interaction with the multiple user applications and the accessing of file servers accessible via the computing system are suspicious based on a result of comparing the monitored accessing of file servers accessible via the computing system to the system resource usage model corresponding to the identity determined to be logged-in to the computing system.

9. The computer-implemented method of claim 1 wherein invoking a security mechanism in connection with the computing system includes logging the identity out of the computing system.

10. The computer-implemented method of claim 1 wherein invoking a security mechanism in connection with the computing system includes requesting authentication information before enabling continued access via the computing system.

11. The computer-implemented method of claim 1 wherein:
determining that the monitored interaction with the multiple user applications is suspicious includes determining that the monitored interaction with the multiple user applications corresponds to a particular level of suspicion from among multiple different levels of suspicion based on a result of comparing the monitored interaction with the multiple user applications to the system resource usage model corresponding to the identity determined to be logged-in to the computing system; and
invoking a security mechanism in connection with the computing system as a consequence of determining that the monitored interaction with the multiple user applications is suspicious includes logging the identity out of the computing system as a consequence of determining that the monitored interaction with the multiple user applications corresponds to the particular level of suspicion.

12. The computer-implemented method of claim 1 wherein:
determining that the monitored interaction with the multiple user applications is suspicious includes determining that the monitored interaction with the multiple user applications corresponds to a particular level of suspicion from among multiple different levels of suspicion based on a result of comparing the monitored interaction with the multiple user applications to the system resource usage model corresponding to the identity determined to be logged-in to the computing system; and
invoking a security mechanism in connection with the computing system as a consequence of determining that the monitored interaction with the multiple user applications is suspicious includes restricting some but not all access via the computing system.

13. The computer-implemented method of claim 1 wherein:
the computing system provides access to multiple resources available over a communications network to which the computing system is coupled communicatively; and
invoking a security mechanism in connection with the computing system includes alerting a mechanism that monitors activity within the communications network to the determination that the monitored interaction with the multiple user applications is suspicious.

14. The computer-implemented method of claim 1 further comprising, responsive to having determined the identity currently logged-in to the computing system, identifying, from among multiple different system resource usage models, a particular system resource usage model as corresponding to the identity determined to be logged-in to the computing system currently, wherein comparing the monitored interaction with the multiple user applications to a system resource usage model includes comparing the monitored interaction with the multiple user applications to the particular system resource usage model identified.

15. The computer-implemented method of claim 1 wherein monitoring interaction with multiple user applications accessible via the computing system includes monitoring interaction with user applications hosted by remote computing systems.

16. A computer-readable storage medium storing instructions that, when executed by a computing system, cause the computing system to:
receive authentication information for an identity;
store the received authentication information for the identity;
allow the identity to log-in to a first session with the computing system;
while the identity remains logged-in to the first session with the computing system, monitor user interaction with multiple user applications accessible via the computing system;
based on monitoring user interaction with the multiple user applications, develop a user application usage model for the identity;
cause the identity to be logged-out from the computing system;
after causing the identity to be logged-out from the computing system, receive a request to log-in the identity to a second session with the computing system, the request including a portion of the authentication information for the identity;
responsive to receiving the request to log-in the identity to a second session with the computing system, compare the authentication information received with the log-in request to the stored authentication information for the identity;
based on results of comparing the authentication information received with the log-in request to the stored authentication information for the identity, allow the identity to log-in to a second session with the computing system;
while the identity remains logged-in to the second session with the computing system, monitor user interaction with multiple user applications accessible via the computing system;
compare the monitored user interaction with the multiple user applications from the second session to the user application usage model developed for the identity;
based on a result of comparing the monitored user interaction with the multiple user applications from the second session to the user application usage model developed for the identity, determine that the monitored user interaction with the multiple user applications from the second session is suspicious; and
as a consequence of determining that the monitored user interaction with the multiple user applications from the second session is suspicious, invoke a security mechanism in connection with the computing system.

17. A computer-readable storage medium storing instructions that, when executed by a computing system, cause the computing system to:
monitor, at one or more unannounced intervals and transparently to any end user of a computing device, interaction that involves the computing device and user applications that are accessible via the computing device;
determine that the monitored interaction is suspicious; and
as a consequence of having determined that the monitored interaction is suspicious, invoke a security mechanism in connection with the computing system.
